(19) United States
(12) Patent Application Publication
(10) Pub. No.: US 2003/0002007 A1
(43) Pub. Date: Jan. 2, 2003

(54) Handheld device with QWERTY keyboard and display

(76) Inventor: James A. Meringer, Phoenix, AZ (US)

Correspondence Address: SPECIALIZED CONTROL SYSTEMS, 4014 WEST VAN BUREN, SUITE 12, PHOENIX, AZ, 85009, US

(21) Appl. No.: 09/896,294

(22) Filed: Jul. 2, 2001

(51) Int. Cl. G09G 5/00

(52) U.S. Cl. 349/169

(57) ABSTRACT

In accordance with the present invention, a portable device is defined for storing and managing data accessed by a user. The portable device includes a microprocessor, memory, a display for text or graphics, and a QWERTY keyboard. The QWERTY keyboard is split into a left subset and a right subset that are complementary halves to a full or partial QWERTY key set. The preferred embodiment arranges the left keyboard subset in a sweeping arc centered about the lower left corner of the device and the right keyboard subset in a complementary sweeping arc about the right lower corner of the device. The left and right halves are spatially positioned with the left complementary subset to the left of the display, and the right complementary subset to the right of the display. The resulting device improves the ergonomics and usability of a portable handheld communication device.

### BACKGROUND OF THE INVENTION

1. Field of the Invention

The present invention relates generally to a new form of data entry and display format as an integral part of a handheld data processing system. More particularly, it relates to such a data entry and display format especially adapted and integrated into a Personal Digital Assistant (PDA) ,two-way interactive paging terminal or cellular telephone.

2. The Relevant Art

Embodiments of the Handheld computer or two way interactive Paging terminals used for computer data entry and communications consist of a display means and a subset of the standard QWERTY keyboard lay-out directly resembling the venerable “QWERTY” keyboard of a typewriter in miniature, consisting of a rectangular, planar cluster of depressible buttons mounted as part of the handheld integrated product. Such products are designed for rapid data entry. In using such a keyboard, the thumbs of the user's left and right hands access their respective keys in a manner which is essentially symmetrical and known as “Thumb Typing”. The prior art allows users to enter data rapidly by allowing the device to be easily placed against the fingers of the two hands by limiting the y dimension to the size of the width of three or possibly four fingers and allowing the thumbs to freely reach individual keys. Research In Motion (RIM) of Canada has provided such a entry system with the RIM 850 Blackberry e-mail device. Such embodiments limit the screen size in the y dimension and force compression of the key switch matrix to limit the y axis dimension to the 3 finger limit.

Most attempts at making the computer data-entry keyboard more compatible with human physiology and the reduction in size required for PDA's and Handheld computers and two-way interactive pagers involve shrinking the size of the key switch matrix or hinging a fold out QWERTY keyboard such as in U.S. Pat. No. 5,712,760 by Coulon, et al. This approach allows for a larger keyboard but limits functionality and increases complexity due to the need of a hinged member.

Other approaches involve the separation of the keyboard into two discrete hand operated members that can be positioned or worn on the separate hands. U.S. Pat. No. 5,481,263 Choi claims a right hand and left hand keyboard member that is operated by the palm and fingers of each hand. This approach requires the device to be supported by some means an does not allow handheld operation required by a PDA device

### SUMMARY OF INVENTION

IT is an object of the present invention to provide an improved means of data entry and display which enables a more natural, ease of viewing, comfort and efficiency of use than any prior Handheld computer or PDA-like device allows.

It is also an object of the present invention that the improved key and screen configuration allow greater stability in handling and a decreased risk against accidental dropping due to the symmetrical gripping about the y and x axis.

It is also an object of the present invention that the familiar QWERTY layout of the prior art be adopted to allow the user familiarity with key location.

It is also an object of the present invention that as one of the embodiments, the display screen can be placed in the landscape orientation as opposed to the profile orientation providing the user with a closer representation of a typical 640×480 VGA screen orientation of the desktop display and still retain handheld operation without the need of support of the display element as would be required with a profile screen mode and the associated moment about the x-axis.

It is also an object of the present invention that the design will allow the use of a larger key switch matrix which without the embodiment will cause the device to grow in both the x and y dimensions and thereby eliminating its “handheld” use

### DETAILED DESCRIPTION

The applicant hereby claims priority of provisional application filed under customer number 000028757 on Apr. 02, 2001. The preferred embodiment is comprised of the following components; a memory for storing a plurality of machine instructions and for storing the data accessed by the user. A processor to operate on input and manipulate the stored data. Also included is a display on which a plurality of lines of data or graphics are presented to the user or in the form of a LCD display or a dot matrix line reader. A QWERTY keyboard further comprised of two complimentary subsets. These are defined as a left side keyboard subset and a right side keyboard subset.

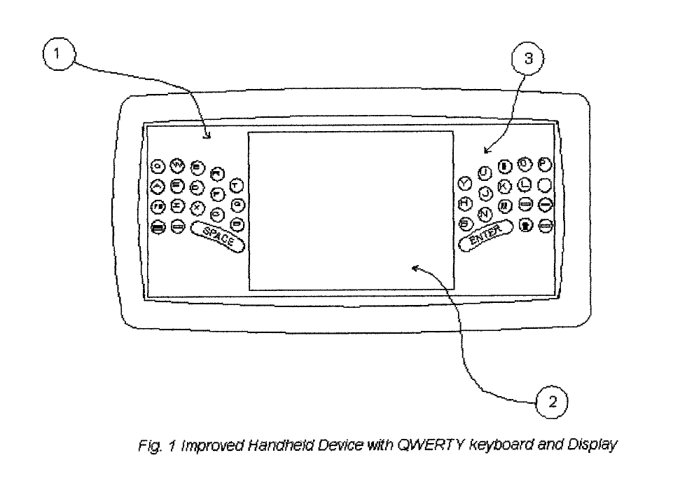

The preferred form factor places the right side keyboard subset along the right side of the display device. The left side keyboard subset will be located along the left side of the display device. The handheld is gripped with the right and left hands by placing the left(FIG. 1, note 1) and right keyboard(FIG. 1 ,note 3) subsets in the left and right fingers respectively and using the thumbs to navigate and enter keystrokes. The right and left side complementary halves have the key switches arranged in a sweeping arc to locate the keys within a ergonomically comfortable distance from the users palm to enable comfortable thumb typing. To improve the grip, the back side of the keyboard sections can be contoured to the index, middle and third finger shapes.

Data or text is presented to the user by the display means (FIG. 1, note2), centered between the immediate left hand and right side keyboard subsets.

The embodiment should be symmetrical about the x and y axis allowing for a balanced ergonomic feel to the user with out moments about either axis. This form factor improves the ease of data entry for a mobile user without the need of a unfamiliar keystroke sequence as required by a non-standard key layout or complicated shift sequences to limit the number of keys required.

What is Claimed is:

1. An integrated keyboard & display terminal for use on a hand-held data processing system comprising: A display device for display of text or graphics; A processor and peripheral devices capable of storing and retrieving files for modification and display, wireless transmission or reception. A left side subset of a QWERTY keyboard placed at the left of the display device to be griped and operated by the left hand and operated by the left thumb A right side subset of a QWERTY keyboard complimentary to the left side subset placed to the right of the display device to be griped and operated by the right hand and operated by the right thumb.

2. The integrated keyboard & display terminal assembly of claim 1 where the left side QWERTY subset is arranged in a sweeping arc arrangement centered about the lower left corner of the device and the right half complementary subset is centered about the right lower corner of the device.

3. The keyboard assembly of claim 1, wherein said auxiliary keyboard/display combination is a re-configurable touch sensitive display screen, or combination of a key switch assembly and touch screen.

4. Where the keyboard/display combination is used as an interface to a cellular telephone apparatus
